(19) United States
(12) Patent Application Publication
(10) Pub. No.: US 2026/0225519 A1
(43) Pub. Date: Aug. 6, 2026

(54) VEHICLE ROOF ASSEMBLY COMPRISING A PANE WITH A LIGHT GUIDE LAYER

(71) Applicant: Webasto SE, Stockdorf (DE)

(72) Inventor: Rudolf DIETL, Stockdorf (DE)

(21) Appl. No.: 19/152,339

(22) PCT Filed: Jan. 23, 2024
(86) PCT No.: PCT/EP2024/051543

§ 371 Date: Jul. 30, 2025

(30) Foreign Application Priority Data
Feb. 2, 2023 (DE) 10 2023 102 556.2

(51) Int. Cl. B60Q 3/20; B60J 3/02; B60Q 3/62; F21V 8/00

(52) U.S. Cl. CPC B60Q 3/20; B60J 3/02; B60Q 3/62; G02B 6/0053; G02B 6/0095

(57) ABSTRACT

A vehicle roof assembly having a pane body assembly which has an exterior-side face facing the vehicle surroundings and an interior-side face facing the vehicle interior and which has a light guide layer, a light source, the light of which can be coupled into the light guide layer, and a shading assembly that comprises at least one guide rail for a shading element, wherein the guide rail rests against the interior-side face of the pane body assembly and delimits a receiving chamber for the light source, the receiving chamber being delimited by the pane body assembly.

### CROSS-REFERENCE TO RELATED APPLICATIONS

This application is a U.S. national phase application filed under 35 U.S.C. § 371 of International Application No. PCT/EP2024/051543, filed on Jan. 23, 2024, published under WO 2024/160600 A1 on Aug. 8, 2024, designating the United States, which claims priority from German Patent Application Number 10 2023 102 556.2, filed on Feb. 2, 2023, which are hereby incorporated herein by reference in their entirety.

### FIELD

The invention relates to a vehicle roof assembly which is provided with a vehicle glass comprising a glass body assembly having a light guide layer into which light from a light source is able to be coupled.

### BACKGROUND

Known from publication WO 2021/198262 A1 is a vehicle roof assembly which is provided with a vehicle glass formed as a fixed roof element or as a cover element of a roof opening system, and by means of which a roof opening can be selectively closed or exposed. The glass body assembly can have a composite structure comprising a light guide layer into which light from a light source is able to be coupled in such a way that the glass body assembly is able to be used as an ambient light illumination unit and in the case of an active light source displays a light pattern which is visible from a vehicle interior.

Furthermore known from practice are vehicle roof assemblies which have a glass body assembly and a roller blind assembly as a shading device, which comprises a roller blind web and in each case one guide rail for the roller blind web on both sides in terms of a vertical longitudinal central plane of the vehicle roof assembly. The guide rails can in each case be mounted on a respective lateral roof post of the vehicle roof assembly, or be a constituent part of said respective lateral roof post.

Known from DE 10 2018 123 196 B4 is a vehicle roof having an illumination element for illuminating a vehicle interior. The illumination element is designed as a light guide or as a light emitting diode strip.

WO 2017/133894 A1 describes a vehicle roof having a roof opening and two guide rails for guiding a movable shading element for shading the roof opening. The guide rails contain a receptacle in which an illumination element is disposed.

WO 2018/206600 A1 discloses a protective device for a vehicle interior, having a flexible planar structure, a guide device on which the flexible planar structure is guided in a linear manner, and at least one light element assigned to the flexible planar structure. In an operating state, the light element dispenses light onto the flexible planar structure.

### SUMMARY

The invention is based on the object of achieving a vehicle roof assembly which comprises a vehicle glass having a glass body assembly comprising a light guide layer, and a light source, the light of which is able to be coupled into the light guide layer, and which is distinguished by an optimized arrangement of the light source.

This object is achieved according to the invention by the vehicle roof assembly having the features of patent claim 1.

Proposed according to the invention is thus a vehicle roof assembly comprising a vehicle glass having a glass body assembly which has an outside facing a vehicle environment and an inside facing a vehicle interior, and which has a light guide layer, a light source, the light of which is able to be coupled into the light guide layer, and a shading assembly which comprises at least one guide rail for a shading element. The guide rail of the shading assembly rests on the inside of the glass body assembly and forms a receptacle space for the light source, said receptacle space being delimited by the glass body assembly.

In the vehicle roof assembly according to the invention, a space in which the light source is disposed, the light of said light source being able to be coupled into the light guide layer, is thus implemented by the guide rail of the shading assembly. In this way, the light source is received by the vehicle roof assembly in such a way that said light source does not compromise the appearance of the vehicle roof assembly. Moreover, the vehicle roof assembly according to the invention is distinguished in that the latter possesses an illumination function, or an ambient light functionality, in the form of the light source and the light guide layer, on the one hand, and on the other hand is also provided with a shading device by means of which the incident light into the vehicle interior is able to be controlled by way of the vehicle roof assembly.

The shading assembly comprises, for example, a roller blind web, a sliding headliner or the like as a shading element.

In one preferred embodiment of the vehicle roof assembly according to the invention, the light source is fixed to the guide rail. In this case, the guide rail also has the function of mounting, or holding, the light source which is disposed below the glass body assembly.

In a special embodiment of the vehicle roof assembly according to the invention, the light source comprises a board which is fixed to the guide rail in particular by way of a retaining groove and/or retaining ribs. In particular in this case, the light source is implemented by means of a so-called PCB (printed circuit board) which on the side facing the glass body assembly is provided with LEDs.

In order not to generate any undesirable illumination effects in the vehicle interior, the guide rail in an expedient embodiment of the vehicle roof assembly according to the invention has at least one contact flange which by way of an opaque sealing element rests on the glass body assembly. The sealing element thus acts in the manner of a light seal which prevents light from the light source exiting by way of a potential gap between the guide rail and the glass body assembly and entering the vehicle interior.

The opaque sealing element can be formed by an adhesive tape which lies in a form-fitting manner on the glass body assembly, or the light guide layer, and on the contact flange of the guide rail, or else be formed by a foam material element which in an analogous manner lies in a form-fitting manner on the glass body assembly and the contact flange of the guide rail.

In one preferred embodiment of the vehicle roof assembly according to the invention, the light source comprises an in particular flexible LED strip, the light of which is directed in the direction of the glass body assembly. A LED strip of this type is in particular a so-called top LED assembly which in the installed position of the vehicle roof assembly dispenses its light upward in the direction of the glass body assembly, or of the light guide layer. The glass body assembly is expediently provided with light coupling means which guarantee that the upwardly dispensed light from the light source is coupled into the light guide layer.

In the installed position of the vehicle roof assembly, the LED assembly dispenses its light upward in the direction of the glass body assembly, or of the light guide layer, for example by way of a light cone of at most 120°, preferably at most 60°, furthermore preferably at most 30°. An angle of the light dispensed by the LED assembly thus deviates from a normal of the light source, thus from a straight line perpendicular to the LED assembly, by at most 60°, preferably at most 30°, furthermore preferably at most 15°.

The light coupling means, by means of which the light dispensed by the light source is able to be coupled into the glass body assembly, can comprise a prism-type coupling element as a light coupling structure, which is disposed on the inside of the glass body assembly facing the vehicle interior, or on the inside of the light guide layer facing the vehicle interior, and onto which the light of the light source is directed. As a result of an internal reflection in the coupling element, the light is guided into the light guide layer in such a way that the light can propagate in the latter due to continuing internal reflection.

In an alternative embodiment of the assembly according to the invention, the light coupling means are disposed between a glass outer body and a glass inner body of a composite structure, said bodies being connected to one another by way of a lamination layer. The light coupling means, which can comprise a geometrically defined prism structure as a light coupling structure and can be formed from an injection-molded polycarbonate element, are then embedded into the lamination layer. The prism structure can in particular be formed by a flexible strip which is disposed in a peripheral region of the composite structure between the glass outer body and the glass inner body. Light from the light source disposed in the receptacle space of the guide rail, which is dispensed in the direction of the glass body assembly, preferably passes through the light guide layer formed by the glass inner body, so as to be then reflected by the prism structure back in the direction of the light guide layer in which the light can then propagate in the transverse direction due to internal reflection or diffusion.

It is likewise conceivable to provide, instead of the prism structure, a diffusion element for diffusing the light and/or a directing element for the defined direction of the light.

The directing element is, for example, a microstructure, a nanostructure or a grid structure.

The directing element can be a mirror structure or a hologram, in particular a volumetric hologram.

The light coupling means which are thus disposed either on the inside of the glass inner body, or of the light guide layer, or between the glass outer body and the glass inner body, enable a high light intensity in terms of the light decoupled in the direction of the vehicle interior.

The glass inner body, preferably on its side facing the lamination layer, has a light decoupling structure. The light decoupling structure, which can be formed by defined diffusion points that are applied to the inside of the glass inner body, defines the light pattern that can be generated by the illumination assembly formed by the light source and the light guide layer. The light decoupling structure decouples the light from the light guide layer in the direction of the vehicle interior.

The shading element of the shading assembly, which is a roller blind web, for example, can itself have an ambient light functionality which is implemented by a peripheral structure and/or a surface structure which is in particular incorporated into the fabric of the shading element. In this way, the shading element can have light-guiding elements, for example light guides, which per se decouple light, or guide light to a light decoupling element that decouples the light in the direction of the vehicle interior. Furthermore, light coupling elements can be provided on the shading element, and/or light coupling elements can be provided on the guide rail, so that light is coupled into the respective peripheral structure and/or surface structure of the shading element. Additionally or alternatively, the light decoupled from the glass inner body can also be able to be coupled directly into the shading element in such a way that this light is able to be utilized by the ambient light functionality of the shading element.

Further advantages and advantageous design embodiments of the subject matter of the invention can be derived from the description, the drawing and the patent claims.

### BRIEF DESCRIPTIONS OF THE DRAWINGS

An exemplary embodiment of a vehicle roof assembly according to the invention is illustrated in a schematically simplified manner in the drawing and will be explained in more detail in the description hereunder. In the drawing:

FIG. 1 shows a schematic top view onto a vehicle roof assembly according to the invention;

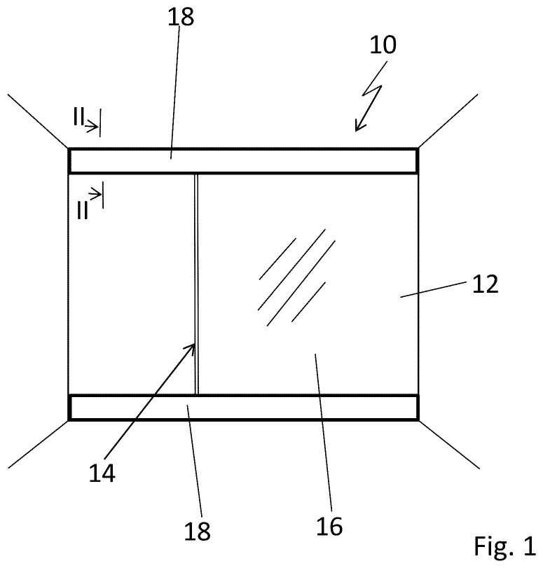

FIG. 2 shows a sectional view through a vehicle glass of the vehicle roof assembly according to FIG. 1 along the line II-II in FIG. 1; and

FIG. 3 shows a sectional view corresponding to that of FIG. 2 through the vehicle glass, but having a roller blind web in the closed position, or shading position, of the vehicle glass.

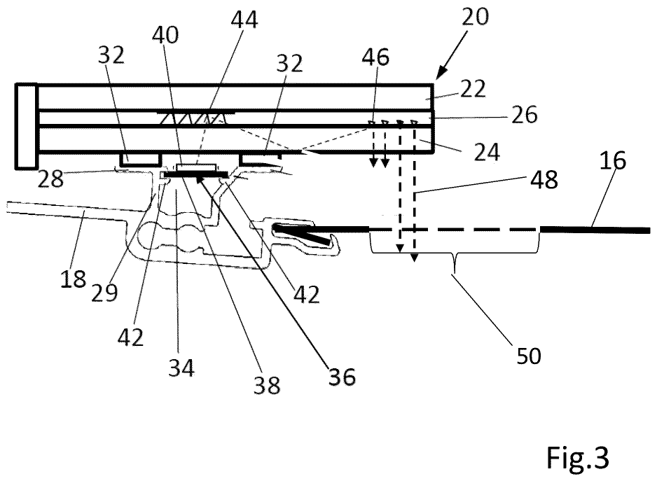

### DETAILED DESCRIPTION

Illustrated in the figures is a vehicle roof assembly 10 of a motor vehicle not illustrated in any more detail, which vehicle roof assembly 10 represents a panoramic roof which has a fixed roof element 12 which is consequently disposed so as to be fixed, or immovable, relative to a vehicle body. The fixed roof element 12 forms a vehicle glass which is provided with an ambient light functionality. Moreover, the vehicle roof assembly 10 comprises a shading assembly 14 by means of which shading of the vehicle interior can be influenced by controlling the incident light into the vehicle interior. The shading assembly 14 in turn comprises a roller blind web 16 as a shading element, and in terms of a vertical roof longitudinal central plane comprises in each case one guide rail 18 on both sides, in which a respective lateral periphery of the roller blind web 16 is guided. The two guide rails 18 are designed to be mutually mirror symmetrical.

The fixed roof element 12, or the vehicle glass formed by the latter, comprises a glass body assembly 20 which has an inside facing a vehicle interior and an outside facing the vehicle environment, and which comprises a glass outer body 22 which forms the outside, and a glass inner body 24 which forms the inside. The glass outer body 22 and the glass inner body 24 are connected to one another by way of a lamination layer 26.

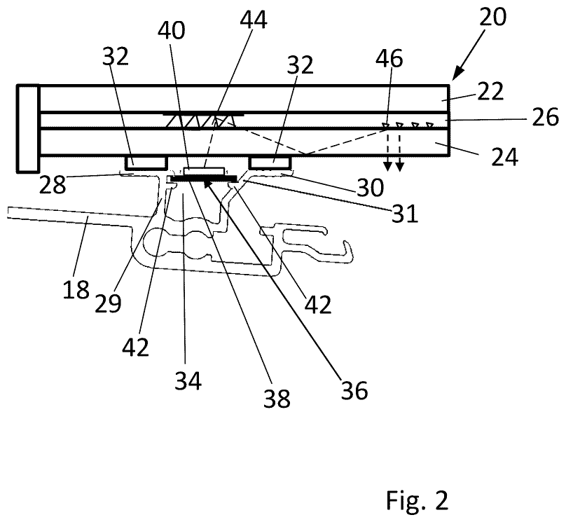

As can be derived from FIG. 2, the guide rails 18 of the shading assembly 14 have in each case two contact flanges 28 and 30. The contact flanges 28 and 30 by way of an opaque sealing element 32, which is formed from a foam material, lie in each case on the inside of the glass inner body 24 and are in each case formed on a rib 29, or 31, respectively, of the guide rail profile forming the respective guide rail 18. Formed by the ribs 29 and 31 of the guide rail profile is a receptacle space 34 which is delimited at the top by the inside of the glass inner body 24, and in the transverse direction is closed off in a light-tight manner by means of the sealing elements 32.

A light source 36, which comprises a support board 38 on which LEDs 40 are disposed, is disposed in the receptacle space 34. The support board 38 is latched to retaining ribs 42 which are integrally molded on the ribs 29 and 31 of the guide rail 18. The LEDs 40 are disposed on the upper side of the support board 38 and dispense their light in the direction of the glass body assembly 20.

Embedded in the lamination layer 26 of the glass body assembly 20 is a prism structure 44 in the form of a flexible strip following the strip-shaped light source 36, said prism structure 44 being made by an injection-molding method from a polycarbonate material and forming a light coupling means by means of which light which is upwardly dispensed by the light source 36 and passes through the glass inner body 24 is able to be coupled into the glass inner body 24 forming a light guide layer.

The glass inner body 24 on its side facing the lamination layer 26 has a light decoupling structure 46 which is formed by diffusion centers by means of which light which propagates in the transverse direction in the glass inner body 24 and/or the lamination layer 26 is dispensed in the direction of the vehicle interior in such a way that a light pattern is created for an observer in the vehicle interior.

The roller blind web 16 in its lateral peripheral regions has in each case one light effect strip 50 which extends in the longitudinal direction of the roller blind along the respective guide rail 18. The light effect strip 50 provides an ambient light functionality which is able to be activated by light beams 48 which are decoupled from the glass inner body 24 in the direction of the vehicle interior. The light effect strip 50 can comprise light-guiding elements, for example light guides, which per se decouple light, or guide the light 48 to a light-decoupling or light-diffusing element.

### LIST OF REFERENCE SIGNS

10 Vehicle roof assembly
12 Fixed roof element
14 Shading assembly
16 Roller blind web
18 Guide rail
20 Glass body assembly
22 Glass outer body
24 Glass inner body
26 Lamination layer
28 Contact flange
29 Rib
30 Contact flange
31 Rib
32 Sealing element
34 Receptacle space
36 Light source
38 Support board
40 LED
42 Retaining rib
44 Prism structure
46 Light decoupling structure
48 Decoupled light
50 Light effect strip

1. A vehicle roof assembly comprising:
a vehicle glass having a glass body assembly which has an outside facing a vehicle environment and an inside facing a vehicle interior, and
which has a light guide layer, a light source, the light of which is able to be coupled into the light guide layer, and
a shading assembly which comprises at least one guide rail for a shading element,
wherein the guide rail rests on the inside of the glass body assembly and delimits a receptacle space for the light source, the receptacle space being delimited by the glass body assembly.

2. The vehicle roof assembly as claimed in claim 1, wherein the light source is fixed to the guide rail.

3. The vehicle roof assembly as claimed in claim 1, wherein the light source comprises a board which is held on the guide rail by a retaining rib.

4. The vehicle roof assembly as claimed in claim 1, wherein the guide rail has at least one contact flange which by way of an opaque sealing element rests on the glass body assembly.

5. The vehicle roof assembly as claimed in claim 4, wherein the sealing element is formed by an adhesive tape or a foam material element.

6. The vehicle roof assembly as claimed in claim 1, wherein the light source comprises a LED strip, the light of which is directed in the direction of the glass body assembly.

7. The vehicle roof assembly as claimed in claim 1, wherein the glass body assembly is provided with a light coupling structure.

8. The vehicle roof assembly as claimed in claim 7, wherein the glass body assembly comprises a glass outer body and a glass inner body which by way of a lamination layer is attached to the glass outer body, and which forms the light guide layer, wherein the light coupling structure is disposed on the side of the glass inner body that faces the guide rail, or between the glass inner body and the glass outer body.

9. The vehicle roof assembly as claimed in claim 8, wherein the light coupling structure comprises a prism structure formed on a flexible strip.

10. The vehicle roof assembly as claimed in claim 8, wherein the glass inner body on its side facing the lamination layer has a light decoupling structure.

11. The vehicle roof assembly as claimed in claim 1, wherein the shading assembly comprises a roller blind web which is guided in the guide rail.
